(19) United States
(12) Patent Application Publication
(10) Pub. No.: US 2009/0026223 A1
(43) Pub. Date: Jan. 29, 2009

(54) Aerosol dispenser apparatus

(76) Inventors: Gerald W. Knebler, Leonard, MI (US); Steven M. Knebler, Dryden, MI (US)

Correspondence Address: ALEX RHODES;UNIT NO. 9, 50168 PONTIAC TRAIL, WIXOM, MI, 48393, US

(21) Appl. No.: 11/880,385

(22) Filed: Jul. 23, 2007

(51) Int. Cl. B67D 5/64

(52) U.S. Cl. 222/174

(57) ABSTRACT

An aerosol spray apparatus for reducing exposure to hazardous chemicals, slips and falls. A container for storing under pressure an aerosol product clamped in a cradle that is attached to a long slender extensible pole which safely spaces the aerosol container a safe distance away from a user of the aerosol container. The pole is mounted on the cradle with a ball joint that allows the cradle to be rotated on the pole. A spray is discharged from the aerosol container by opening a valve in the container with a pull cable. The cradle is capable of carrying a wide range of container sizes

### FIELD OF THE INVENTION

This invention relates to aerosol dispensers and more particularly to an aerosol apparatus for reducing health hazards and slips and falls.

### BACKGROUND OF THE INVENTION

Aerosol products provide several advantages over liquid products, including ease of application, cleanliness and reduced risk of skin contact. They include paints, insecticides, lubricants, disinfectants, cleaning agents, deodorants, air fresheners and adhesives.

However, the benefits are offset with significant health hazards. Four health hazards have been identified, namely, solvent content, propellants, active ingredients and the nature of aerosol sprays. Many aerosols contain solvents which emit vapors that are dangerous if breathed too long or in too high concentrations. Excessive solvent intake can cause headaches, weakness, fatigue and in extreme cases a loss of consciousness. Solvent skin contacts can make skin vulnerable to dermatitis. Long term solvent exposure can damage the heart, liver, kidneys and the central nervous system. Butane, the most common propellant, is extremely flammable.

The hazards of active ingredients vary according to the ingredient involved. By way of example, adhesives, cleaning agents, insecticides, etc. contribute to the hazards of a product as they are deposited in the eyes and internally in nose, throat, lungs and stomach. The physical aspects of the aerosol spray itself is a health hazard. The small droplets of solvent, propellant, and active ingredients are susceptible to deep breathing into the lungs and the larger droplets for deposit on the internal surfaces of the nose, throat, lungs and stomach.

Climbing with and without ladders is often used to apply aerosol sprays to remote and difficult to reach objects such as a hornet's nest. There is always a danger of injury from a slip or fall. Over 17,000 Americans die each year as a result of a slip, trip or fall. A Florida survey indicated that nearly 25 percent of all serious disabling work injuries are due to falls. Over 60 percent of elevated falls are from less than 10 feet.

### SUMMARY OF THE INVENTION

The primary object of the present invention is to reduce the health hazards, slips and falls that are associated with aerosol sprays. Another object, in addition to the foregoing object, is to facilitate the use of aerosol sprays. The invention resides in its ability of its components, individually and collectively, to accommodate a wide range of aerosol containers, prevent aerosol sprays from affecting the health of consumers and direct aerosol sprays to targeted areas.

The aerosol spray apparatus comprises a cradle for supporting an aerosol container, an extensible support structure on which the cradle is pivotally mounted and a means for initiating a spray from the aerosol container. In a first aspect, the cradle is rotatable about a single axis with respect to the support structure. In a second aspect, the cradle is attached to the support structure with a ball joint which allows the cradle to be rotated in any direction with respect to the support structure.

In employing the teaching of the present invention, a plurality of alternate constructions can be provided to achieve the desired results and capabilities. In this disclosure, only several embodiments are presented for the purpose of disclosing our invention. However, these embodiments are intended as examples only and should not be considered as limiting the scope of our invention.

The foregoing features, benefits, objects and best mode of practicing the invention and additional benefits and objects will become apparent from the ensuing detailed description of a preferred embodiment and the subject matter in which exclusive property rights are claimed is set forth in the numbered claims which are appended to the detailed description of the preferred embodiment.

### BRIEF DESCRIPTION OF THE DRAWINGS

The invention will be better understood and further objects, characterizing features, details and advantages thereof will appear more clearly with reference to the diagrammatic drawings illustrating a presently preferred specific embodiment of the invention by way of non-limiting example only.

FIG. 1 is a front view of an aerosol dispenser apparatus according to our invention.

FIG. 2 is a partial left elevational view of the aerosol apparatus.

FIG. 3 is a cross-sectional view taken on the line 3-3 in FIG. 1.

FIG. 4 is a rear elevational view of the aerosol apparatus.

FIG. 5 is a plan view of the aerosol apparatus.

FIG. 6 is a cross-sectional view taken on the line 6-6 in FIG. 3.

FIG. 7 is a full left elevational view of the aerosol apparatus.

FIG. 8 is a first optional operative left elevational view of the aerosol apparatus.

FIG. 9 is a cross-sectional view taken on the line 9-9 in FIG. 7.

FIG. 10 is a cross-sectional view taken on the line 10-10 in FIG. 7.

FIG. 11 is a second optional operative left elevational view of the aerosol apparatus.

FIG. 12 is a left elevational view of an alternate embodiment of the aerosol apparatus.

FIG. 13 is a cross-sectional view taken on the line 13-13 in FIG. 12.

FIG. 14 is a partial left elevational view of a second alternate embodiment of the aerosol apparatus.

FIG. 15 is a plan view of a third alternate embodiment.

FIG. 16 a cross-sectional view taken on the line 16-16 in FIG. 15.

FIG. 17 is a partial plan view of the third alternate embodiment.

FIG. 18 is a cross-sectional view taken on the line 18-18 in FIG. 17.

FIG. 19 is an optional operative left elevational view of the third alternate embodiment.

FIG. 20 is a partial rear elevational view of a fourth embodiment of the aerosol dispenser apparatus.

FIG. 21 a cross-sectional view taken on the line 21-21 in FIG. 20.

### DETAILED DESCRIPTION OF A PREFERRED EMBODIMENT

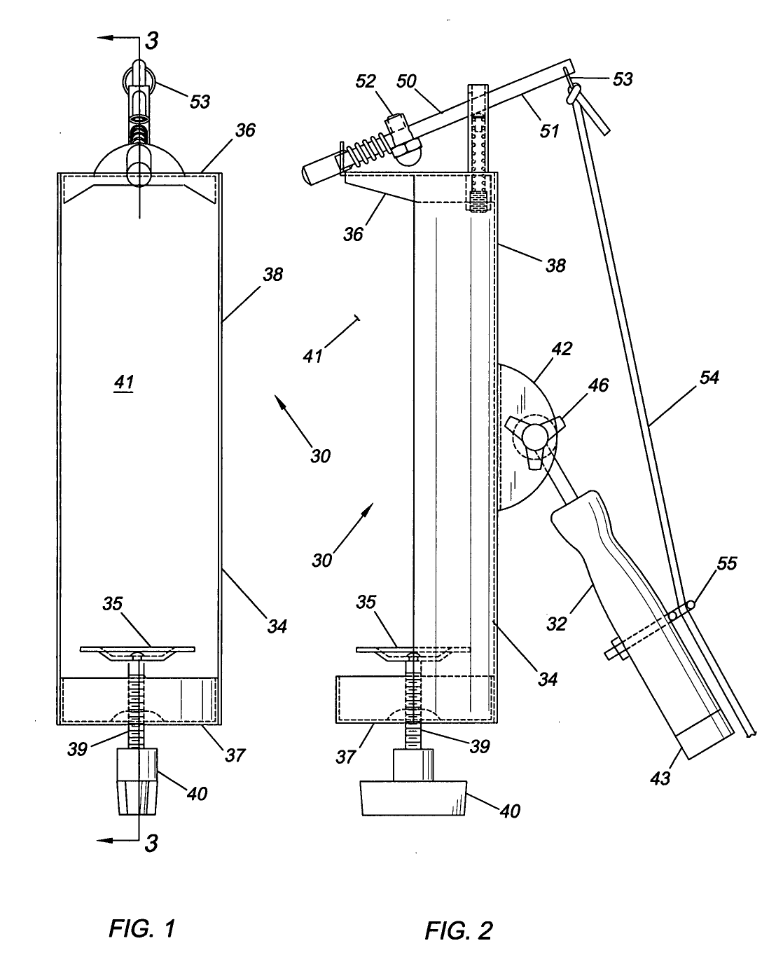

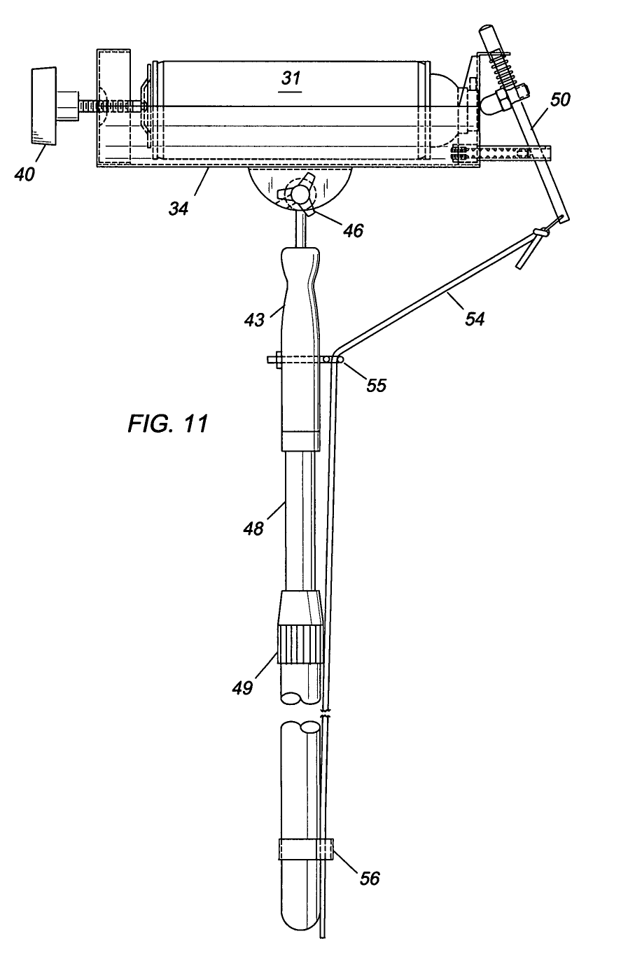

Referring now to the drawings wherein like numerals designate like and corresponding parts throughout the several views, in FIGS. 1 through 11, inclusive, an aerosol spray apparatus 30 is shown, according to our invention. One distinguishing feature of our invention is that an aerosol container 31 is mounted for rotation with respect to a support structure 32. Another feature is that the aerosol container 31 is supported in a cradle 34 which is able to accommodate a wide range of aerosol containers. Another distinguishing feature is that the aerosol container 31 is attached to an extensible pole 33.

As shown in FIGS. 1 through 6, the cradle 34 functions in the same manner as the popular C-clamp. It is comprised of a movable lower jaw 35, a fixed upper jaw 36, a lower cup 37 and an arcuate member 38 which connects the lower cup 37 to the fixed upper jaw 36.

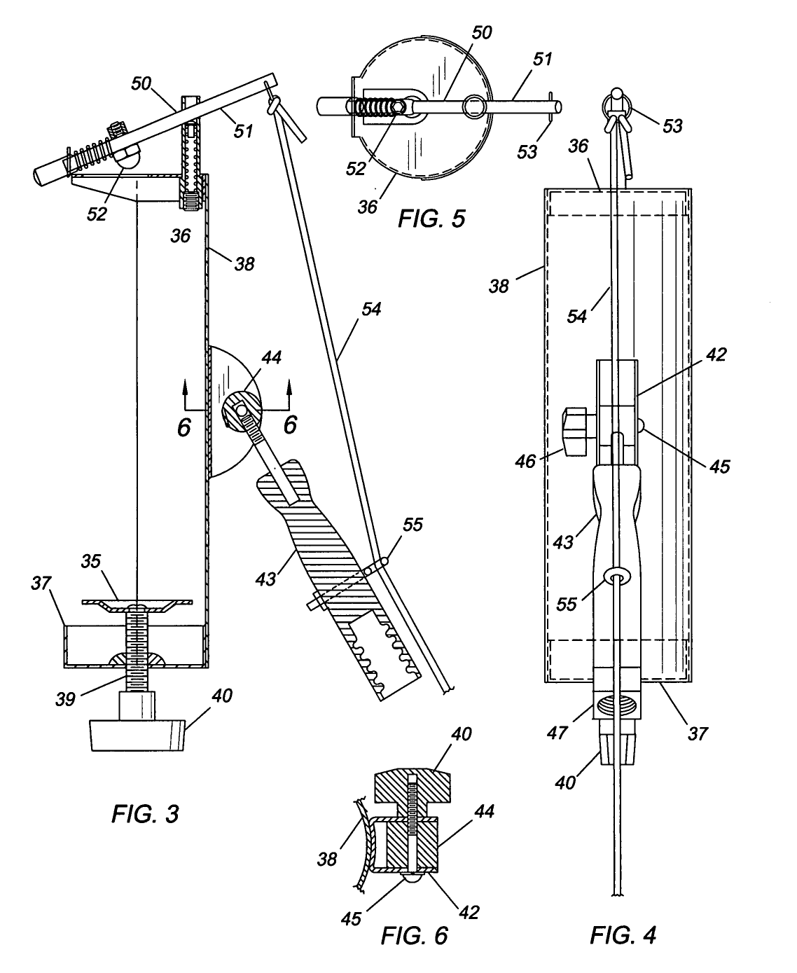

The movable lower jaw 35 is movable toward and away from the fixed upper jaw 36 by a shaft 39 which threadably engages the lower cup 37. At an outer end of the shaft 39 is a knob 40 for rotating the shaft 39 to advance and retract the lower jaw 35. The front 41 of the cradle 34 is open to install and remove the aerosol container 31. The aerosol container 31 is installed by retracting and advancing the lower jaw 35. As shown in FIGS. 3 and 6, on the rear of the cradle 34 is a channel shaped bracket 42 for pivotally attaching a short slender cylindrical handle 43.

At one end of the handle 43 is a transverse boss 44 for pivotally attaching the handle 43 to the bracket 42 with a bolt 45 and thumb nut 46. The angular relationship between the handle 43 and aerosol container 31 is adjustable by loosening the thumb nut 46, rotating the handle 43 and tightening the thumb nut 46.

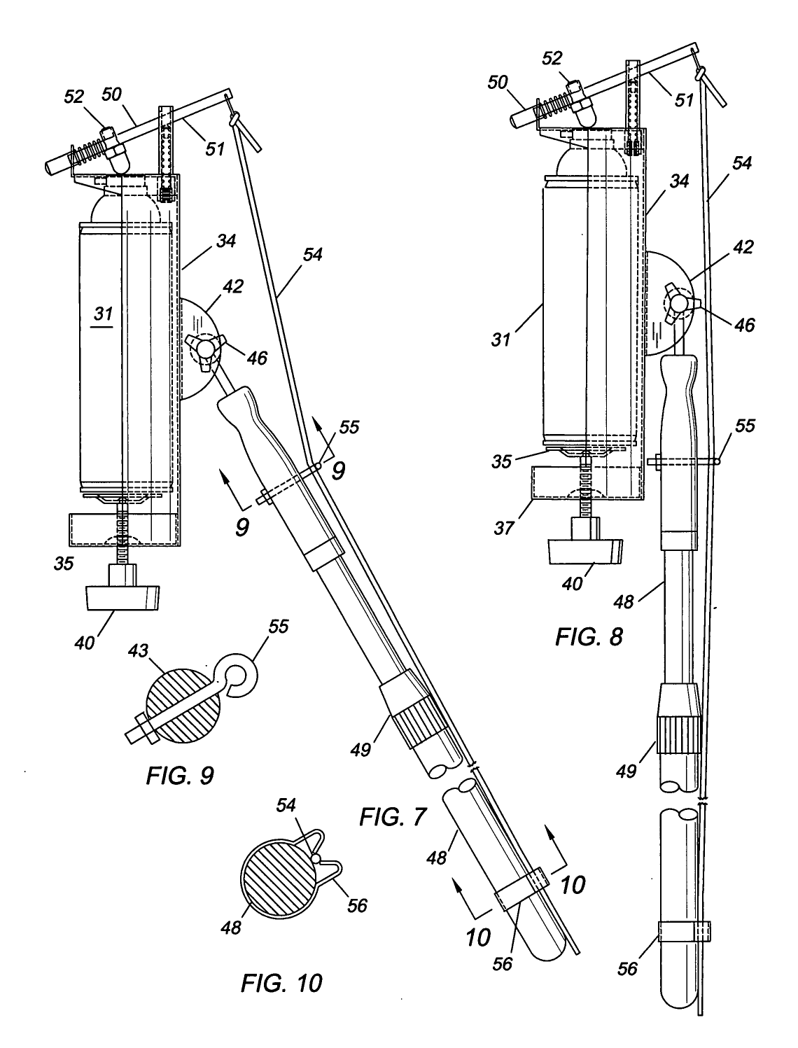

The outer end portion 47 of the handle 43 is threaded for attaching a long slender two piece pole 48. As shown in FIGS. 7 and 8, the pole 48 is extensible and is comprised of a pair of engaging members and a nut 49 that fixes the spatial relationship between the telescoping members. As shown in FIGS. 1, 2, 3 and 5, on the top of the cradle 34 a rocker arm assembly 50 is pivotally mounted for operating the aerosol container 31. The rocker arm assembly 50 is comprised of a rocker arm 51 pivotally attached to the upper jaw 36 and resiliently supported on an opposite end portion to the upper jaw 36. At an intermediate portion of the rocker arm 51 there is a striking member 52 which strikes and opens a valve in the aerosol container 31 when the rocker arm 51 is rotated.

At an end portion of the rocker arm 51 is a thin circular wire ring 53. A pull cable 54 is attached to the wire ring 53, extends through a cable guide 55 on the handle 43 and is clipped to a retainer 46 on an end of the pole 48. When the cable 54 is pulled, the rocker arm 51 rotates to cause the striker 52 to depress a valve in the aerosol container 31 and initiate an aerosol spray.

The attachment of the handle 43 to the cradle 34 allows the orientation of the handle 43 to be changed with respect to the cradle 34. FIGS. 7, 8 and 10 show several of the orientations. In FIG. 7, the aerosol container 31 has an angular orientation, in FIG. 8 a parallel orientation and in FIG. 10 a perpendicular orientation. The rotatable handle 43 is a substantial improvement over the prior art.

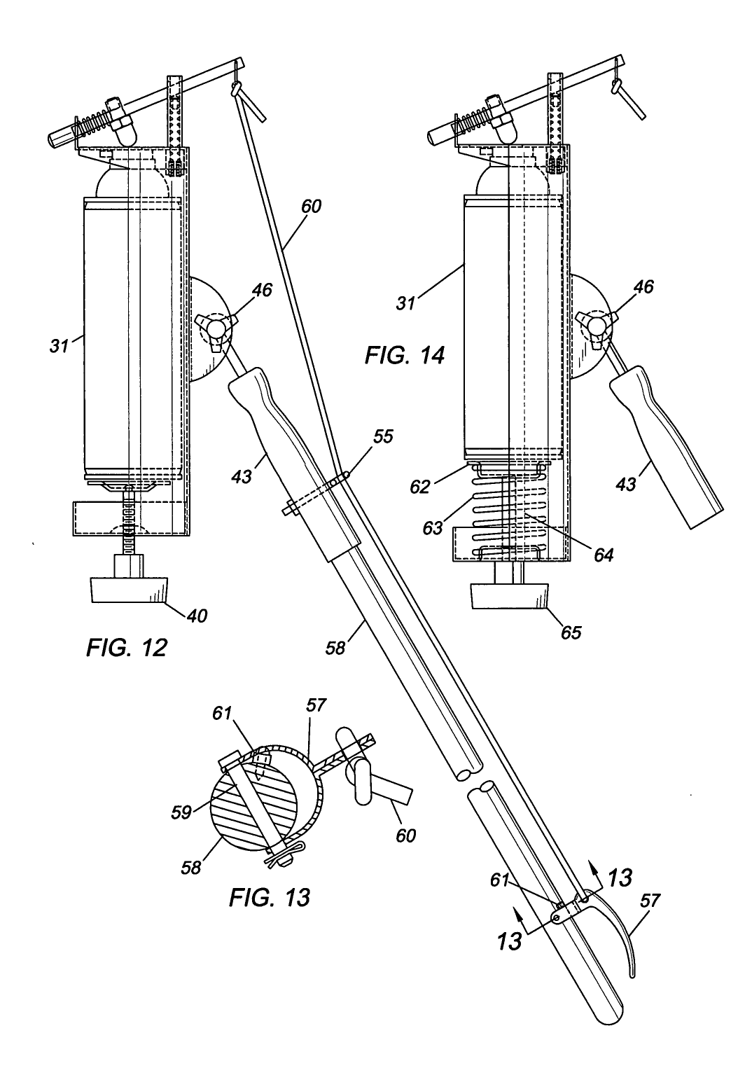

With reference to FIGS. 12 and 13, an embodiment is shown in which a handle 57 is pivotally attached to a one-piece non-extensible pole 58 with a pin 59. When the handle 57 is depressed, a cable 60, attached to an end of the handle 57, rotates the rocker arm 51 to initiate the aerosol spray. A stop 61 on the pole 58 limits the rotation of the handle 57 when the handle 57 is released.

In FIG. 14 an optional means for clamping the aerosol container 31 in the cradle 34 is shown. A lower jaw 62 is urged against the bottom of the aerosol container 31 with a coil compression spring 63. To insert or remove the aerosol container 31, the coil spring 63 is compressed by a pull on a short shaft 64 and a handle 65 which are slidably mounted in the cradle 34.

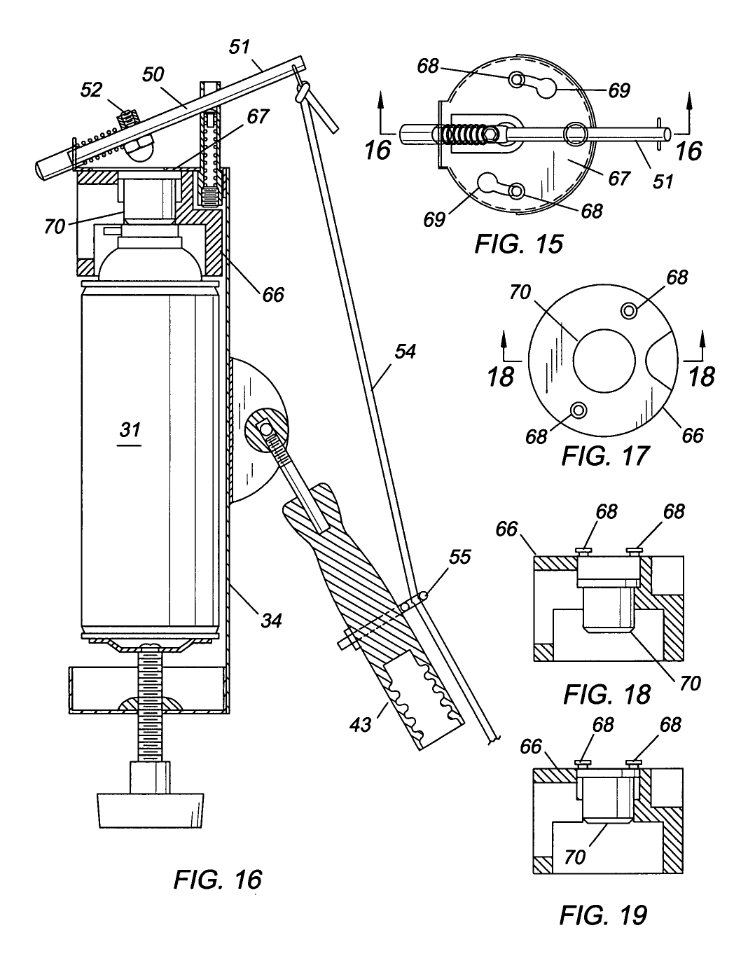

In FIGS. 15 through 19, an embodiment is shown for increasing the range of sizes of the aerosol container 31. A removable two-piece spacer 66 is retained to an upper jaw 67 by inserting and rotating a pair of pins 68 in apertures 69 of the upper jaw 67. In the center of the spacer 66 is a slidable plunger 70 which engages the valve on the aerosol can 31 when the plunger 70 is depressed by the striker 52 of the rocker arm 51. In FIGS. 18 and 19, the plunger 70 is shown in fully retracted and depressed positions.

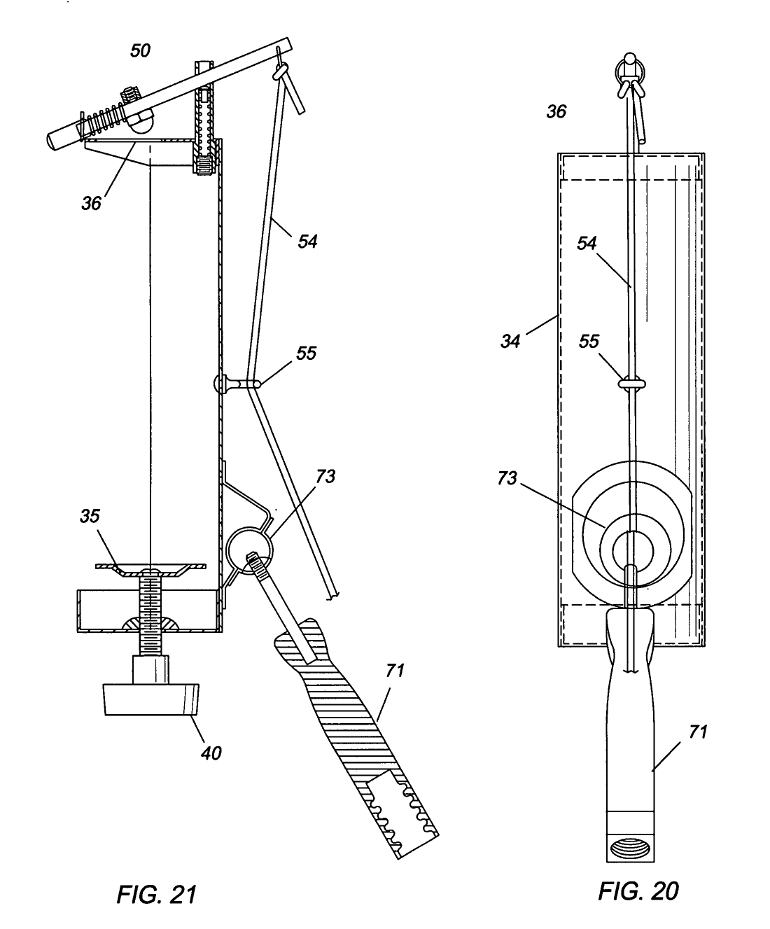

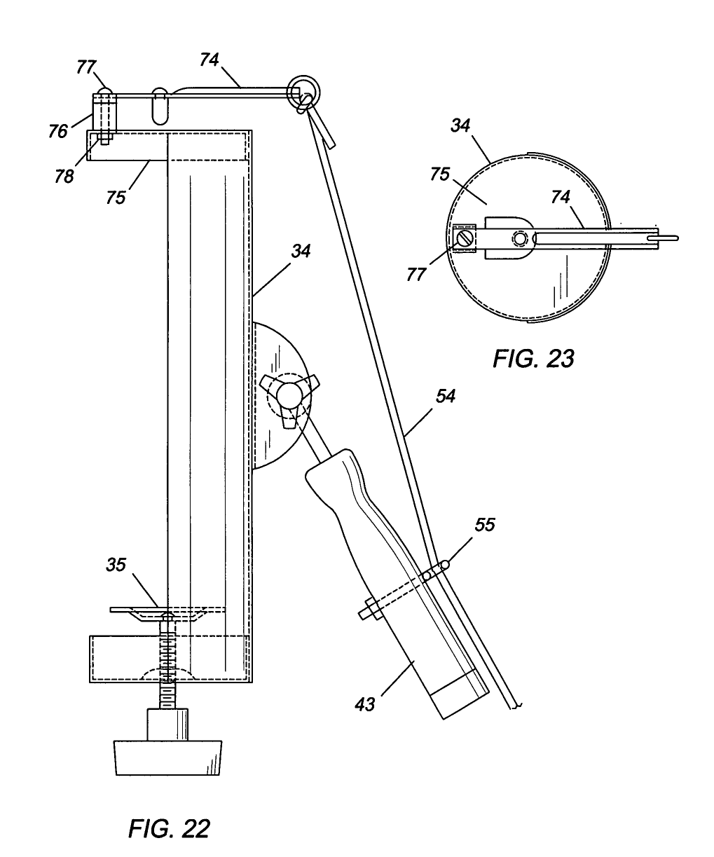

In the embodiment of FIGS. 20 and 21, a handle 71 is connected to the cradle 34 with a ball and socket joint 73 which provides a greater degree of freedom by allowing the handle 71 to be rotated about the center of the ball and socket joint 73. In the embodiment shown in FIGS. 22 and 23, a construction is shown wherein a rocker arm 74 is a resilient leaf spring that is attached to a fixed upper jaw 75 with a spacer 76, bolt 77 and nut 78. A striker 79 is attached to the leaf spring 74.

From the foregoing it will be appreciated that our invention is an effective, easy to use aerosol apparatus which provides numerous benefits over the prior art. Although only several embodiments of our invention have been described, it will be apparent that other embodiments can be developed by changes which are obvious to persons skilled in the art, such as insignificant variations in thicknesses and compositions of materials, obvious substitutions of materials and obvious substitutions in the order and steps in our method without departing from the spirit thereof.

What we claim is new is:

1. An aerosol spray apparatus for reducing exposure to hazardous chemicals, slips and falls, said apparatus comprising: a container for storing under pressure an aerosol product; said container having a valve for releasing an aerosol spray; a cradle for carrying said aerosol container, said cradle having an open front portion for installing and removing said container, a fixed upper jaw for gripping an upper portion of said container and a movable lower jaw axially aligned with said upper jaw for gripping a lower portion of said container and a means for axially moving said lower jaw to clamp and release said aerosol container in said cradle; a means attached to said upper jaw for opening said valve in said container for discharging said aerosol spray from said container; a handle pivotally attached to said cradle for rotating said handle on said container, said handle having a threaded end portion for attaching a long slender pole; and a long slender pole threadably attached to said handle.

2. The aerosol spray apparatus recited in claim 1 wherein said means for opening said valve in said container comprises a rocker arm, said rocker arm having an end portion pivotally attached to said fixed upper jaw; an opposite end portion resiliently supported on said fixed upper jaw; and a striker between said rocker arm end portions.

3. The aerosol spray apparatus recited in claim 1 wherein said means for moving said lower jaw toward and away from said upper jaw comprises a shaft threadably attached at one end portion to a lower portion of said cradle; and a knob for rotating said shaft attached to an opposite end portion of said threaded shaft.

4. The aerosol spray apparatus recited in claim 1 wherein said means for moving said lower jaw toward said upper jaw comprises; a coil spring; a shaft slidably mounted in said cradle, said shaft attached at an end portion to said lower jaw for moving said lower jaw away from said upper jaw by compressing said coil spring; and a knob attached to an opposite end portion of said shaft for pulling said shaft to compress said spring.

5. The aerosol spray apparatus recited in claim 1 wherein said pole is an extensible two piece telescoping pole.

6. The aerosol spray apparatus recited in claim 1 wherein said means for pivotally attaching said pole to said cradle comprises a channel shaped bracket attached to a side portion of said cradle, a boss attached to an end portion of said handle, said boss having an aperture in orthogonal relationship to said handle for pivotally mounting said handle to said channel shaped bracket.

7. The aerosol spray apparatus recited in claim 1 wherein said means for pivotally attaching said pole to said cradle comprises a ball joint attached to a side portion of said cradle rotating said handle on said cradle.

8. The aerosol spray apparatus recited in claim 1 wherein said means for opening said valve in said container comprises a leaf spring rocker arm, said leaf spring rocker arm having one end attached to said fixed upper jaw and an opposite end portion for attaching a cable; and a striker between said rocker arm end portions.

9. An aerosol spray apparatus for reducing exposure to hazardous chemicals, slips *and falls, said apparatus comprising: a base structure for supporting an aerosol container at a safe distance away from a user of said container, said base structure having a cradle for carrying said aerosol container, a long slender pole pivotally attached to said cradle for spacing said aerosol container away from said user, a means for discharging an aerosol spray from said aerosol container when said aerosol container is spaced away from said user; and a means for pivotally mounting said aerosol can on an end portion of said pole.

10. The aerosol spray apparatus recited in claim 9 wherein said means for discharging an aerosol spray from said aerosol container comprises a striker on said cradle for opening a valve in said aerosol container; and a cable for engaging said striker with said valve.

11. An aerosol spray apparatus for reducing exposure to hazardous chemicals, slips and falls, said apparatus comprising: a container for storing under pressure an aerosol product; said container having a valve for releasing an aerosol spray; a cradle for carrying said aerosol container, said cradle having an open front portion for installing and removing said container, a fixed upper jaw for gripping an upper portion of said container and a movable lower jaw axially aligned with said upper jaw for gripping a lower portion of said container and a means for axially moving said lower jaw to clamp and release said aerosol container in said cradle; a removable two-piece spacer attached to said upper jaw for clamping an extended range of containers in said cradle; a rocker arm attached to said upper jaw for opening said valve in said container to discharge said aerosol spray from said container; a pull cable attached to said rocker arm for operating said arm; a handle pivotally attached to said cradle for rotating said handle on said container, said handle having a threaded end portion for attaching a long slender pole; a means for pivotally attaching said handle to said cradle; and a long slender extensible pole threadably attached to said handle.

12. The aerosol spray apparatus recited in claim 11 wherein said means for pivotally attaching said handle to said cradle is a ball joint.
